(19) United States
(12) Patent Application Publication
(10) Pub. No.: US 2012/0174852 A1
(43) Pub. Date: Jul. 12, 2012

(54) OPEN WATER SWIM BELT

(76) Inventor: SCOTT GREENSTONE, South Orange, NJ (US)

(21) Appl. No.: 13/338,205

(22) Filed: Dec. 27, 2011

Related U.S. Application Data
(60) Provisional application No. 61/428,656, filed on Dec. 30, 2010.

(51) Int. Cl. G09F 17/00

(52) U.S. Cl. 116/173

(57) ABSTRACT

An open water swim belt consisting of a flag assembly having a flag attached to a flag pole, a base assembly that is positionable about a swimmer by attaching an adjustable belt, and a transition that extends perpendicular from the base. The transition is equipped with a receiver that is capable of receiving a flag pole. The swim belt is worn by a swimmer by positioning the base assembly against the lumbar section of the swimmer's back then securing the base in position by tightening the adjustable belt. A flag may be inserted into the transition of the base assembly and include identifiers, colors and a light to enhance the visibility of the swimmer. The swim belt provides comfort and safety by allowing a flag to provide visibility of the swimmers presence to boats and other surface water craft in the area of the swimmer.

### RELATED APPLICATIONS

This patent application claims priority to U.S. Provisional Patent Application Ser. No. 611428,656 filed Dec. 30, 2010 entitled “Open Water Swim Belt” and currently co-pending.

### FIELD OF THE INVENTION

The present invention relates generally to exercise devices. The present invention is more particularly, though not exclusively, related to a belt worn around a swimmer's waist to enhance the swimmer's safety and visibility in open water swim environments.

### BACKGROUND OF THE INVENTION

Over the years, a variety of swim apparel and equipment has been developed. The basic swimsuit has evolved from elaborate costumes popular centuries ago, to streamlined suits made from state-of-the-art materials. Overall, a great deal of technology and innovation has been contributed to the advancement of swimming apparel to enhance a swimmer's safety and comfort while swimming.

In addition to improvements in apparel, a significant focus has been on improving the equipment used by swimmers to improve their safety while in the water. Some such improvements have focused on propulsion, such as swim fins and flippers, while others have focused on swimmer comfort such as wetsuits and headgear. These devices are clearly useful and provide the swimmer with insulation from the often harsh environment, however, they are often bulky, impede the swimmer's movements, and slow progress through the water.

While these various improvements provide a swimmer with numerous options for clothing and equipment, none have yet provided a swimmer with a device that provides for enhanced safety and visibility that does not restrict movement while swimming. Moreover, the devices currently available for increasing the visibility of swimmers in open water are often bulky, impede the natural swimming motions, and slow the swimmer's progress through the water.

In light of the above, it would be advantageous to provide a device for swimmers that is comfortable to wear, provides increased visibility, and does not restrict the swimmer's movements. It is further advantageous to provide a device for swimmers that does not create hydrodynamic drag, or alter buoyancy significantly, so that the swimmer can train effectively for endurance events. It is also advantageous to provide an accessory device for a swimmer that is cost effective, and relatively easy to manufacture.

### SUMMARY OF THE INVENTION

The open water swim belt of the present invention includes a flag assembly having a flag attached to a flag pole, and a base assembly that includes a panel positionable about a swimmer by attaching an adjustable belt, and formed with a base. A transition extends from the base and is equipped with a receiver for receiving the flag pole.

The open water swim belt of the present invention is worn by a swimmer with the panel positioned against the lumbar back of the swimmer, and secured in place by tightening the adjustable belt. A flag may be inserted into the receiver to extend perpendicularly upwards from the base when worn by a swimmer. This flag can include an alpha/numeric identifier, such as a participant number for a sporting event, and can include a brightly colored international scuba diver insignia.

The open water swim flag belt of the present invention provides visibility of swimmers to boats and other surface watercraft. The product will provide an enormous level of comfort and safety to those wishing to swim in open water where surface water craft may exist.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a side view of the open water swim belt of the present invention showing the invention as worn on a typical swimmer (shown in dashed lines) and shows the panel of the base assembly seated against the lumbar portion of the swimmer's back, with the receiver extending perpendicularly upwards from the base assembly to receive the flag assembly having a flexible pole which presents a highly visible flag above the water line;

FIG. 2 is a top plan view of the base assembly of the open water swim belt of the present invention showing the base assembly having a belt that is adjustable with a pair of adjustment clips extending from the panel;

FIG. 3 is a top plan view of the base assembly showing the rounded leading edge and tapered trailing edge of the transition, and the circular receiver which provide support to the flag assembly while minimizing hydrodynamic resistance to the swimmer's advancement;

FIG. 4 is a side view taken along line 4-4 of FIG. 3 showing the base assembly and the shape of the transition and attachment to the base;

FIG. 5 is a side view of the base assembly taken along line 5-5 of FIG. 3 showing the base assembly and the shape of the transition with the angled leading edge and sloped trailing edge;

FIG. 6 is an exploded view of the open water swim belt of the present invention showing the flexible flag assembly removed from the base assembly; and

FIG. 7 is a side view of an alternative embodiment of the open water swim belt of the present invention showing the flag assembly attached to the base assembly and equipped with a power source in electrical connection to an illumination device at the uppermost portion of the flag pole to provide an illuminated warning indicator.

### DETAILED DESCRIPTION OF A PREFERRED EMBODIMENT

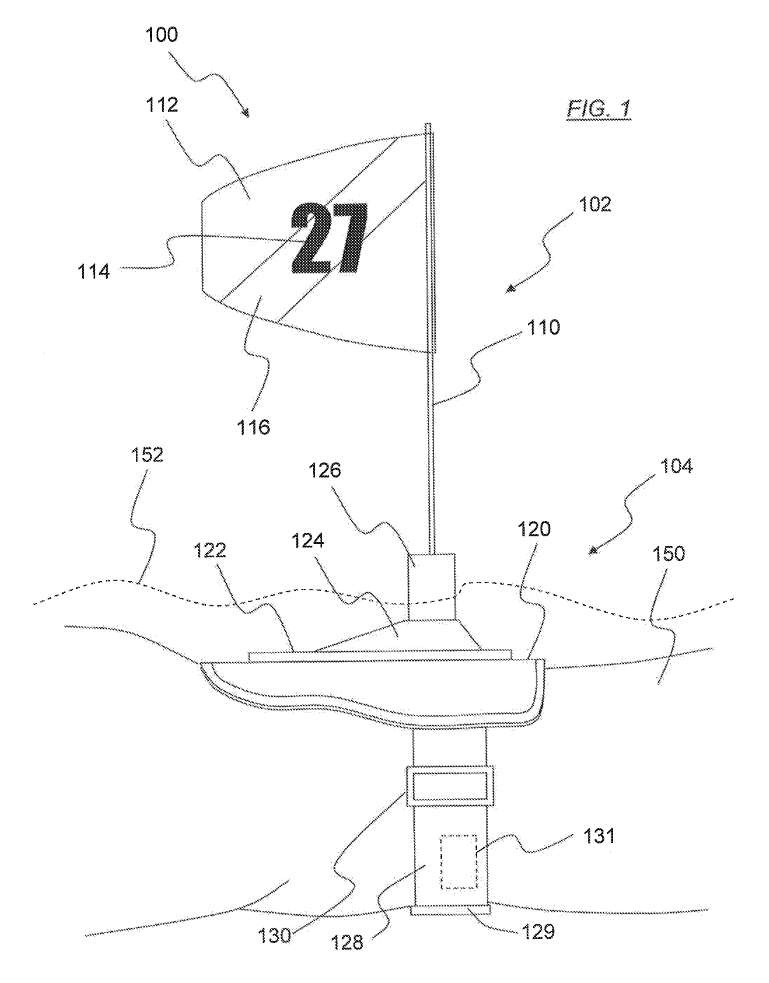

Referring initially to FIG. 1, the open water swim belt of the present invention is shown and generally designated 100, and includes a flag assembly 102 and a base assembly 104. Flag assembly 102 includes a flag pole 110 and a flag 112. As shown, flag pole 110 is relatively small in cross-section, such as less than one inch, so that any drag created by the flag pole through the wind or water is minimized. Further, the flag 112 is lightweight.

Flag 112 is made from any material known in the art suitable for water and sun environments. For instance, flag 112 may be made from a lightweight nylon panel having resistance to saltwater and sunlight. In a preferred embodiment, the flagpole is made from a UV safe, mold and mildew resistant nylon, and has some flexibility to it. At the top of the flagpole 110 is a brightly colored (possibly customizable) waterproof and UV resistant fabric flag 112 to call attention to the location of the swimmer. Flag 112 may have an alpha-numeric indicator 114, such as number “27”, and may be equipped with a universal diver's insignia of a diagonal stripe 116.

Flag 112 is attached to flag pole 110 by any means known in the art. For instance, flag 112 may be made with a sleeve to receive the upper end of the flagpole 110, or flag 112 may be attached with any adhesive or heat attachment method known in the art. Alternative methods of attachment are fully contemplated without departing from he spirit of the invention. Also, flag 112 may be integrally formed with flagpole 110 in a single piece, such as injection molded plastic. In this embodiment, the flagpole 110 and flag 112 may maintain its original shape and maintain the flag 112 in a raised position, yet be sufficiently pliable for safety and durability.

Base assembly 104 includes a panel 120 having a base 122, a transition 124, and a receiver 126. As shown, receiver 126 is supported in a position perpendicular to panel 120 by transition 124 and base 122. In a preferred embodiment, base 122, transition 124 and receiver 126 may be integrally formed in a single piece to provide strength, durability, and ease of manufacturing. Base 122 is securely fastened through any means known in the art to panel 120. In one embodiment, base 122 may be sewn onto panel 120 using durable stitching; in other embodiments, base 122 may be attached to panel 120 using adhesives or heat attachment techniques known in the art.

Receiver 126 is shown receiving flag pole 110. Flag pole 110 may be inserted into receiver 126 and retained using a friction force, or flag pole 110 and receiver 126 may be equipped with complementary threads whereby flag pole 110 is threadably received within receiver 126.

Panel 120 is also equipped with a belt 128 that extends from each side of base 122 and formed with adjustment clips 130 to adjust the length of belt 128. A fastener clip 129, or buckle, is provided to allow the belt 128 to be clipped around the waist of a swimmer, and adjustment clips 130 can be adjusted to tighten the belt 128 so that the base assembly 104 remains in the proper position on the swimmer. The belt 128 will be designed utilizing neoprene fabric for the bulk of the back of the product with stretchable fabric to form the front aspects of the belt 128. Belt 128 may be formed with an unobtrusive waterproof pocket as shown by dashed lines 131. In a preferred embodiment, the waterproof pocket 131 consists of a removably attachable bag that has three slide zippers that fold over each other to maintain maximum watertight integrity. It is to be appreciated by someone skilled in the art that most any design of a removably attachable waterproof bag will satisfy the needs of the swimmer. The buckle 129 will provide ease of entry/exit while not providing any discomfort to the user. The belt 128 size is designed as one size fits all so as to accommodate any size body frame.

The side view of the open water swim belt 100 of the present invention shown in FIG. 1 is worn on a typical swimmer 150 and shows the panel 120 of the base assembly 104 seated against the lumbar portion of the swimmer's back, with the receiver 126 extending perpendicularly upwards from the base assembly 104 to receive the flag assembly 102 which presents the highly visible flag 112 high above the water line 152.

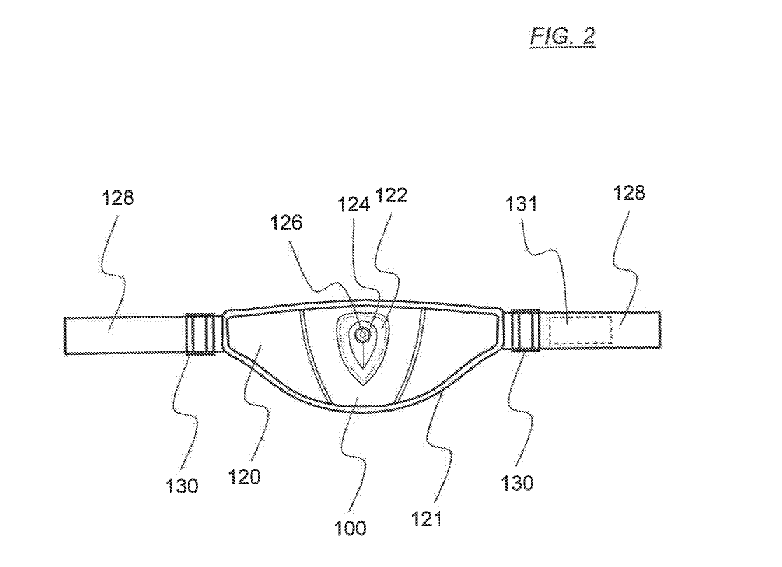

Referring now to FIG. 2, a top plan view of the base assembly 104 of the open water swim belt 100 of the present invention is shown. The base assembly 104 includes panel 120 that in a preferred embodiment, is made from a black neoprene and trimmed along its outer edge with a black binding 121 to prevent fraying of the neoprene panel 120. Base 122 is made from a black vinyl plastic that is lightweight and includes integral transition 124 and receiver 126.

As shown, receiver 126 is supported in a position perpendicular to panel 120 by transition 124 and base 122. Panel 120 is secured to the swimmer by belt 128 that is adjustable with a pair of adjustment clips 130. Clip 129 (not shown this Figure) provides for the easy attachment and removal of device 100 from the swimmer. In a preferred embodiment, belt 128 is made from a 1.5″ elastic soft-stretch material that is saltwater and ultraviolet light resistant.

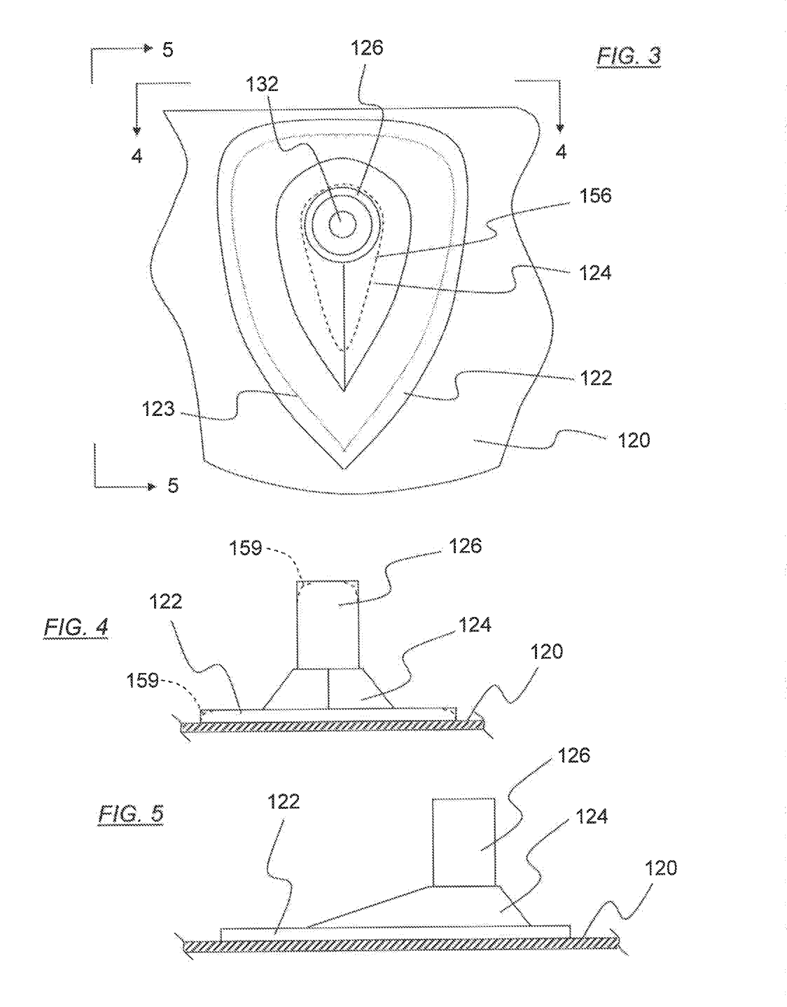

Referring now to FIG. 3, a top plan view of the base assembly 104 is shown. From this view, the rounded leading edge and tapered trailing edge of transition 124 is clearly seen. This shape provides for optimal water dynamics and decreases the drag that the device 100 creates as the swimmer swims through the water. Also, receiver 126, which provide support to the flag assembly 102 is circular in cross-section in order to minimize hydrodynamic resistance to the swimmer's advancement. The circular bore 132 of receiver 126 is also shown and sized to receive closely the flag pole 110 of flag assembly 102. Also from this view, the stitching 123 shows the method of attachment of the base 122 to panel 120.

Referring to FIG. 4, a side view taken along line 4-4 of FIG. 3 shows the base assembly 104 and more specifically, the shape of the transition 124. Similarly, FIG. 5 is another side view of the base assembly taken along line 5-5 of FIG. 3 and shows base assembly 104 and the shape of the transition 124 with the angled leading edge and sloped trailing edge. It is to be appreciated that the shape of transition 124 is intended to provide vertical support for receiver 126, while minimizing the drag to the swimmer. Also from these figures, it is to be appreciated that the various edges (shown in dashed lines 159) of the base 122, transition 124, and receiver 126 can be rounded to further enhance safety and to decrease the drag created by wearing the device 100.

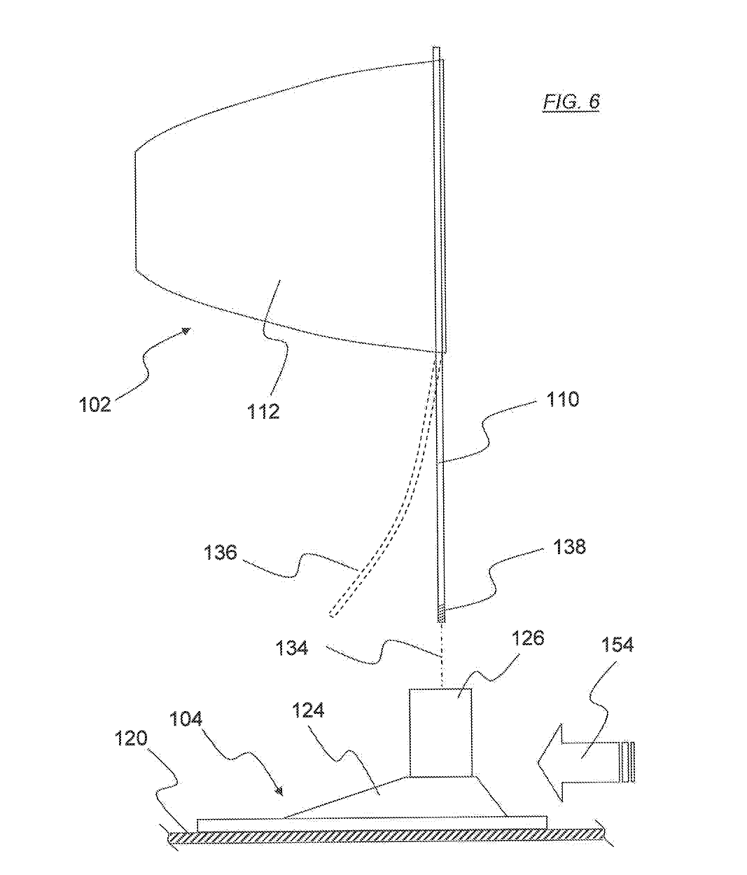

FIG. 6 shows an exploded view of the open water swim belt 100 of the present invention and depicts the flexible flag assembly 102 removed from the receiver 126 of base assembly 104. From this view, the flexibility of the flag pole 110 is shown by dashed lines 136. This Figure also depicts the threads 138 formed on the insertion end of flag pole 110 and it is to be appreciated that receiver 126 is formed with complementary threads (not shown) to threadably secure flag pole 110 into the receiver 126.

Also from FIG. 6, the direction of water flow 154 is shown, and provides clarity to the shape of transition 124 which is intended to provide minimal resistance to the movement through the water. In order to further minimize the drag through the water, receiver 126 may be formed with a cross-section that reduces drag. For instance, with reference back to FIG. 3, the cross-section may be shaped as shown by dashed lines 156. This cross-section has a rounded leading edge and a tapered trailing edge in order to minimize the drag through the water.

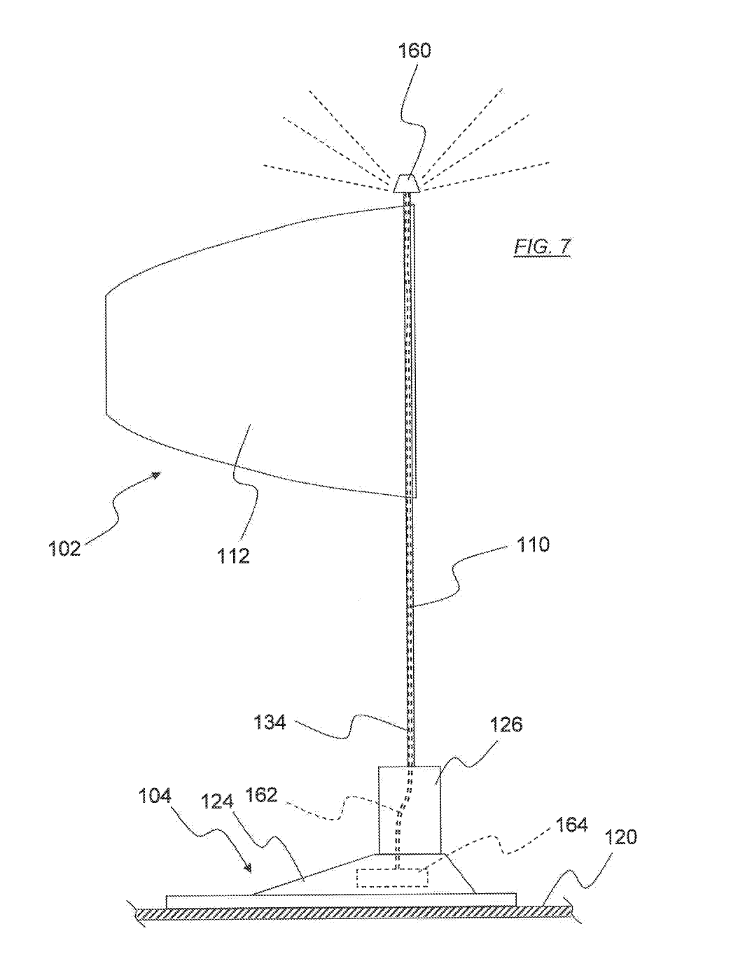

Referring to FIG. 7, a side view of an alternative embodiment of the open water swim belt 100 of the present invention shows the flag assembly 102 attached to the base assembly 104. A light source 160 is attached to the distal end of flag pole 110 and in electrical connection via cable 162 to a battery source 164 positioned within base assembly 103, such as in transition 124, The light source 160 is positioned on the uppermost portion of the flag pole 110 to provide an illuminated warning indicator that is visible during early morning or late evening swimming, or while swimming in the dark. In an alternative embodiment, light source 160 can include a vertical light bar positioned longitudinally alongside or within flag pole 110.

The specific size and shape of flag 112 as shown herein is merely exemplary of a preferred embodiment, and other sizes and shapes are fully contemplated herein. The materials described in conjunction with the open water swim belt 100 of the present invention are merely exemplary of a preferred embodiment. The specific materials are not limiting in nature, and other materials are fully contemplated herein.

While there have been shown what are presently considered to be preferred embodiments of the present invention, it will be apparent to those skilled in the art that various changes and modifications can be made herein without departing from the scope and spirit of the invention.

The invention claimed is:

1. An open water swim belt for increasing a swimmer's visibility and comfort, the open water swim belt comprising:
a panel having an inner surface positionable adjacent a wearer's lumbar back, and an outer surface;
a base assembly extending from said outer surface;
a belt extending from said panel and forming a loop therewith; and
a flag assembly extending from said base assembly away from said panel.

2. The flag assembly of claim 1, further comprising:
a flag pole with a relatively small cross-section to reduce drag and made from a flexible and lightweight material that is UV, mold, and mildew resistant;
a flag made from a lightweight material that is UV, mold, and mildew resistant and suitable for water and sun environments; and
a means for attaching said flag to said flag pole.

3. The flag assembly of claim 2, further comprising:
a flag pole made of nylon; and
a flag made of nylon.

4. The flag assembly of claim 1, further comprising a flag integrally formed with a flag pole to form a single piece.

5. The flag assembly of claim 4, further comprising said flag and flag pole made from injection molded plastic.

6. The flag assembly of claim 1, further comprising a light source positioned on the uppermost portion of said flag pole.

7. The flag assembly of claim 6, further comprising said light source being a light bar positioned longitudinally along said flag pole.

8. The flag assembly of claim 6, further comprising said light source being integral to said flag pole.

9. The base assembly of claim 1, further comprising:
a base;
a transition extending away from said base and formed with a receiver to receive said flag assembly.

10. The base assembly of claim 9, further comprising:
said receiver mounted perpendicularly to said base and supported by said transition and said base; and
said receiver designed to receive and secure said flag pole.

11. The base assembly of claim 9, further comprising said base, said transition, and said receiver integrally formed as a single piece.

12. The base of claim 9, further comprising:
a rounded leading edge and a tapered trailing edge.

13. The panel of claim 1, further comprising:
said panel made from neoprene; and
said panel sized larger than said base.

14. The belt of claim 1, further comprising:
adjustment clips to adjust the length of said belt; and
a fastener clip to secure said belt around a swimmer.

15. The belt of claim 14, further comprising a removably attachable and closable waterproof pocket.

16. The base of claim 1, further comprising said base having multiple edges and said edges rounded to enhance swimmer safety and to reduce drag.
